(19) United States
(12) Patent Application Publication
(10) Pub. No.: US 2019/0213519 A1
(43) Pub. Date: Jul. 11, 2019

(54) Productivity Improvement Device

(71) Applicant: Saent Holding Ltd., Hong Kong (HK)

(72) Inventors: Tim Metz, Bejing (CN); Russell Haines, Sunnybrook (NZ)

(21) Appl. No.: 15/863,814

(22) Filed: Jan. 5, 2018

(51) Int. Cl. G06Q 10/06; G06F 3/02; G06F 3/01

(52) U.S. Cl. CPC G06Q 10/06398; G06F 3/017; G06F 3/0202

(57) ABSTRACT

A system comprising a physical button to initiate a session, the session designed to enable a user to be focused, the physical button communicating with a software application through a network connection, and a computer system including the software application to track how the user utilizes the computer. The button designed to provide a visual display of a count-down timer for the session, to encourage the user to maintain focus through the session. The computer system further designed to track whether the user remains productive through the session, and to generate statistics at an end of the session, the statistics usable by the user to encourage focus.

### RELATED APPLICATION

The present application is a national state filing of PCT/US2016/041198 filed on Jul. 6, 2016, which claims priority to U.S. Provisional Patent Application No. 62/189,168 filed on Jul. 6, 2015, and incorporates both of those applications by reference in their entirety.

### TECHNICAL FIELD

The present invention relates to productivity, and more particularly to a system to enhance productivity.

### BACKGROUND ART

As people become busier and use more and more electronic devices, they are falling into the trap of multitasking. Research shows that 97% of the population performs worse on tests when they use multitasking, even though they believe they do not.

Multitasking does not mean being involved in multiple projects at the same time. That is something unavoidable in today's society. Multitasking generally involves “task-switching,” working on this document for five minutes, then checking an email, then back to this document, then on to Facebook for a bit, which leads me to reading an interesting article and then finally back to writing this document.

The cost of task switching is the biggest productivity killer around, yet most people do not even realize it. For this reason, helping and encouraging people not to continually task-switch, is the biggest, but also easiest productivity gains one can make.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is network diagram of one embodiment of the system.

FIG. 2 is a block diagram of one embodiment of the button, computer system, and auxiliary device.

FIG. 3A is a diagram of one embodiment of the circuitry of the button.

FIG. 3B an illustration of an exemplary embodiment of the button.

FIG. 3C is an exploded diagram of one embodiment of the button.

FIG. 3D is a circuit diagram of one embodiment of the button.

FIG. 4 is an overview flowchart of one embodiment of using the system.

FIG. 5 is a table of exemplary project selections, for various types of projects.

FIG. 6 is a flowchart of one embodiment of community and competition process.

FIG. 7 is a flowchart of one embodiment of the activation of the button.

FIG. 8A-8I are exemplary user interface features.

FIG. 9 is a block diagram of one embodiment of a computer system.

### DETAILED DESCRIPTION

The present application describes a system that guides people away from multitasking and to being focused and productive, using a combination of hardware and software. In one embodiment, the system also allows users to set goals and creates games (competitions) based on appropriate metrics. In one embodiment, the system tracks “focused minutes.” A focused minute is a minute of uninterrupted work, in which the user works on only one thing (so no task-switching). The tracking of such focused minutes is to productivity, what steps are to health, a simple, yet powerful motivational metric. It is motivational because by measuring and quantifying behavior, users can start to set goals for improvement. It also allows the introduction of social competition, which is a strong motivational force.

The system is designed to discourage people from switching tasks. The system awards points for focused minutes, and gives a notification/warning before enabling switching to a different task. The system also provides a visual feedback of the short burst focused minutes that the user is committing to. This enables the user to visually see the time, and remain focused, without needing to switch between applications, which would lead to lower productivity. Because the system provides a tangible reminder, on the desk, in plain view, it is a useful motivator. It's easy to forget about an application on the computer, but the button is a continuous physical reminder to stay focused. It's a visual cue that helps users develop a new behavior, stick to it, and monitor their progress.

In one embodiment, the system tracks which program or website is active when they hit the “Start” button. In one embodiment, when a user indicates that he or she wants to leave that program to move to another application or site, the system will display a reminder to nudge the user back to what they were doing. The button is a start button for focused productivity as well as a sort of digital egg timer, which serves to give a visual clue as to where in the productivity cycle the user is, to the user and in one embodiment to third parties to prevent interruptions. In one embodiment, the system further enables the user to set challenges, and goals, to increase their focused time. In one embodiment, the system may score users on their achievement of goals the goals they set. This encourages setting reasonable goals, and continuous goal setting and improvement. In one embodiment, it also permits time tracking. In one embodiment, the user may set a session objective, indicate how long they want to work on it, then hit the button. Once they indicate that they are done by activating the button again (or reach the end of the session), the time can be logged. In one embodiment, such logged time can be exported to a report. This can be very useful for professions that track project time, or to determine how long various types of projects take.

In one embodiment, the system creates behavioral “profiles” and adjusts the applications that the user can switch between based on the profile. In one embodiment, a single user may have multiple types of “project profiles.” For example, a web designer may have a “research and brainstorm” project profile, a “preparing website” project profile, and a “QA testing” project profile. For example, the “research and brainstorm” project profile, may use the system as follows:
Initiate “research and brainstorm” profile.
System identifies Photoshop, Word, and design and research related websites as appropriate applications for the selected current profile.
User can switch between appropriate applications, without terminating the session, or getting any nudges.
If the user switches to Facebook, email, or any other program unrelated to the current profile, the system pops up to nudge them back.

By defining behavioral profiles, and associated project profiles, the system can ensure that the user isn't disrupted as when switching between applications within the active project, and that focused minutes are maintained. Note that an application that would normally be classified as productive may not be classified as productive under a particular profile. For example, a video editing tool may not be classified as productive during a “Design research” project session, when it would be considered productive in the context of a Video project.

In one embodiment, the user is asked to identify the project profiles he or she utilizes. In one embodiment, each project profile has one or more applications and/or websites associated with it. In one embodiment, the user may define the association between project profiles and applications and websites. Alternatively, such associations may be pre-defined. In one embodiment, the user adjusts the associations based on their use pattern. In one embodiment, the system may include a predefined list of applications/sites and their categorization. A single site, or application, can appear in multiple project classifications. For example, but Q&A and writing code sessions would need access to one or more appropriate repositories. In one embodiment, the system may also include a blacklist set of sites that are warned-away from for any project, though the user can, in one embodiment, create projects that include that. For example, someone who works in marketing may have a need to work on a Facebook post, and the system can track that as productive minutes, despite the fact that generally Facebook is a distraction.

In one embodiment, the classification of applications into projects may be created by the community. For example, a large number of people may set up “Design research” project types, and identify applications and sites that are productive. The system may then utilize this data to create and/or improve a predefined list of applications and sites and their categorization. In one embodiment, the user may provide his or her job description, and the system may propose one or more project session types, based on data from other users who have provided the same job description. This enables crowd-sourcing of such data, and increases consistency and efficiency for the user.

In one embodiment, the system provides “points” for productive behavior. In one embodiment, the reward structure is slightly non-linear and gets higher as the user manages to work uninterrupted for a longer stretch of time. This is because they are more likely to get in a state of flow, the longer they stay focused without multitasking or distraction. In one embodiment, the system calculates success in 10 minute intervals. By working with ten-minute cut-off points, users are encouraged to push a bit further and make it to the next ten-minute milestone. In one embodiment, the calculation (“algorithm”) is not disclosed to the user.

In one embodiment, the system may provide additional ways for people to earn points. For example, in one embodiment, users earn extra points if they follow the POMODORO TECHNIQUE® (25 minutes of focused work, five minute break, then 25 minutes of focused work again, and so on). In one embodiment, when people use certain productivity apps, such as EVERNOTE™ and ASANA™, they can earn additional points. For example, in one embodiment, this could mean the user gets ten extra points each day they use EVERNOTE™, and another ten if they use ASANA™. Alternative point values may of course be used.

In one embodiment, reducing the number of times email is checked may also provide extra points. The purpose of the scoring is to encourage productive behaviors and increase focused time. Therefore, in one embodiment, the scoring calculation may be further adjusted as the system analytics determine which behaviors are most productive, based on data from many users. In one embodiment, the system's analytic goal is to identify the digital foot print of an optimally productive person, and attempt to guide others to a similar behavior set. Note that optimal productivity is likely to vary based on job description, employer, and various other factors. The system is, in one embodiment, tracks these factors.

In one embodiment, the system also encourages the creation of a community, or multiple communities of users who want to be productive and do great work. In one embodiment, the system allows people to “follow” and/or connect with highly productive users (based on their Productivity Score) or “regular” people who match them—in a similar industry or job type. Following, in one embodiment, simply entails being provided information about how this person achieves their goals or receiving suggestions or recommendations from the user. Connection implies a two-way interaction.

In one embodiment, the community may also provide competition. A user may choose to compete with friends, others in the same company, others in a similar or same line of business, etc. A user may be part of multiple communities, and participate on multiple leaderboards. The user will be able to connect to the people he or she wants to share a productivity score with. From there a leaderboard will be created, which shows how the user is doing compared to the selected others who are also using the system. In one embodiment, the system may be able to work based on the software, without the button. This may enable a user to compete with someone who has not purchased the system. In one embodiment, there may also other leaderboards users can access and participate in. For example, a company may have a company-wide leader board, the entirety of the community may have a leaderboard, etc.

In one embodiment, the system may provide a way to be aware the sessions of friends, or coworkers. For example, a user might be able to see how long a session of a friend or colleague will still take, so the user will know when they can interrupt with a question. This is very useful especially in an open plan office environment, where a quick glance at the button display would keep a focused and productive user from being interrupted by unnecessary questions. This information might also be made available through other elements of the system, such as a mobile app or an online page.

In one embodiment, the system may provide a platform for highly productive users to teach others. This platform may be used to identify a relevant audience, for example for someone who coaches or guides people toward improving their own optimal productivity. The community also provides a way to quickly find productivity tools and content relevant to the users, recommended by their peers. The system may also make recommendations based on the usage data from the members of the community, in one embodiment. In one embodiment, the system will make application, website, or other recommendations based on the actual usage of the community in a specific job category. For example, the system may provide data such as “In the past month, these 5 new design applications were most popular amongst designers using the system.”

In one embodiment, in addition to enabling a user to more efficiently utilize their computer, or tablet, the system also interacts with the user's mobile device. Mobile devices are one of the biggest distractions for people Not only is there FACEBOOK™, TWITTER™, and INSTAGRAM™, there are also text messages, notifications, games, and other things that take away focus. In one embodiment, the system sets the mobile device to a “do not disturb” mode automatically when a productivity session is launched. In one embodiment, for mobile devices that do not provide this capability, the user or system may initiate an application which suppresses the notices and other distractions form the mobile device. In such an instance, if a user leaves the application, e.g. uses the phone during a session, the session is automatically broken. This ensures mobile distractions are also taken into account.

In one embodiment, in addition to fostering focused minutes, the system ensures that users take the breaks that maximize their productivity. It's now well-established amongst productivity experts, that breaks and their length, are as important as many other approaches to improve focus and quality of work. The taking of breaks, and optionally the use of the break time, may also be used in scoring of a user.

For example, when someone works in 25 minute intervals (sessions), it's recommended that they take a 5 minute break after each session, before getting back to work. If instead the user is utilizing 90-minute sessions, it's recommended they take a longer break (at least 15 minutes). By taking regular breaks, the user can remain focused during the work session, without distraction. Breaks not only provide a way to relax and refresh the brain, they also allow the user to do those distracting activities like responding to emails and text messages, that would otherwise interfere with their focus.

Therefore, in one embodiment, the system encourages claiming the break time. In one embodiment, the system asks the user: “What do you want to do in your break?” In one embodiment, the system may provide suggestions about what to do during a break time. For example, the user may be encouraged to walk around, get a drink, stretch, etc. In one embodiment, the system can suggest inspirational content with various themes (professional, music, relaxing, fun, etc.).

In one embodiment, the score earned by the user/points awarded may be used in various ways in addition to the participation on the leaderboard. For example, in one embodiment, users may be able to spend the points they've earned on exclusive content. In one embodiment, users may even obtain goods or services—for example premium app subscriptions from partners, event tickets in their local areas, discount coupons on books, or benefits from their employer. In one embodiment, the system may provide coupons to popular applications, in cooperation with the application makers, to encourage productivity.

Because the system provides a physical button to start a session, the commitment to focus is more powerful than simply using a timer function on the computer. The button also visually indicates where the user is in his or her session. It can serve as a Do Not Disturb sign for others—people can see when the user is in focus time from the device. Besides the physical commitment, the button is also a constant physical and visual reminder and cue for the user's intention to change their behavior, which is very important aspect of a habit loop.

In one embodiment, the button may be used with other applications which track time, and/or control the user's computer system. In one embodiment, applications may interface with the button via an application user interface (API) that enables various other applications to use the communication and feedback features of the button.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

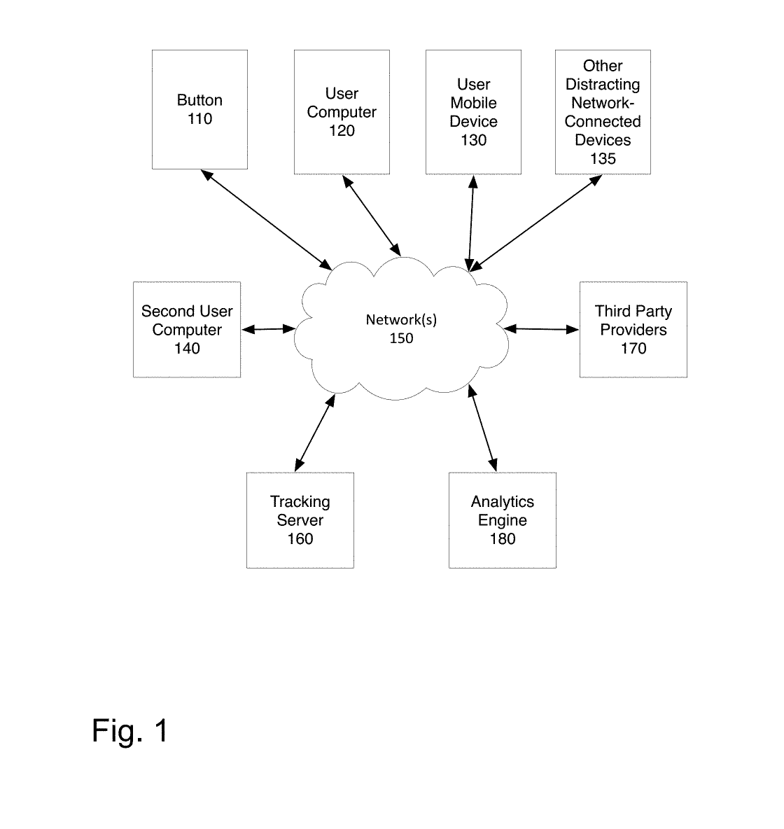

FIG. 1 is network diagram of one embodiment of the system. The system in one embodiment includes a button 110 which interacts with software on the user's computer 120, such as a desktop or laptop or distributed computing system. In one embodiment, the button 110 may further be paired with a second user computer 140. In one embodiment, a single button may be paired with multiple devices. In one embodiment, button 110 also can send messages or control user mobile device 130, or other devices connected via the network 135. The mobile device 130 may be a smart phone or similar device. The other devices 135 which may interact with the software and/or button 110 may include a smart watch, tablet computer, media player, etc. In one embodiment, when the software on the user's computer 120 is active, the user mobile device 130 and other connected device 135 are placed in a state that suppresses interruptions. In one embodiment, the system may provide a way to break through this suppression, for emergency/urgent messaging.

In one embodiment, the system also includes tracking server 160. Tracking server 160 in one embodiment includes a repository of the use data from a plurality of users. Tracking server 160 may include a database or other structure to store user data. In one embodiment, the system may work without the server, with all processing taking place on the user's computer. In one embodiment, the user specific data is tracked on the user's device and computer, and only cumulative/anonymous data is shared through the server. Though tracking server 160 is shown as one device, it should be understood that it could be a cloud-based system, a distributed system, or implemented in another way. The tracking server's function is to provide historical data. In one embodiment, tracking server 160 may further provide competition logics, enabling users to pit themselves against their friends, coworkers, class mates, or others who are a good match for them for productivity. In one embodiment, the user must opt into any such competition.

Analytics engine 180 takes the cumulative data from a large number of users, and creates recommendations. In one embodiment, the system groups users in various ways, for example by job description, hours worked, location, seniority, gender, etc., in analyzing the best recommendations to make. Recommendations may include the optimal length of a session, what to do during a break, definitions for project-based sessions, etc.

Third party software may include any application accessible to the user via user computer 120, second user computer 140 (which may be a tablet computer), or user mobile device 130. Third party software may provide additional productivity features. In one embodiment, third party software may also provide additional value in competitions, as will be described below.

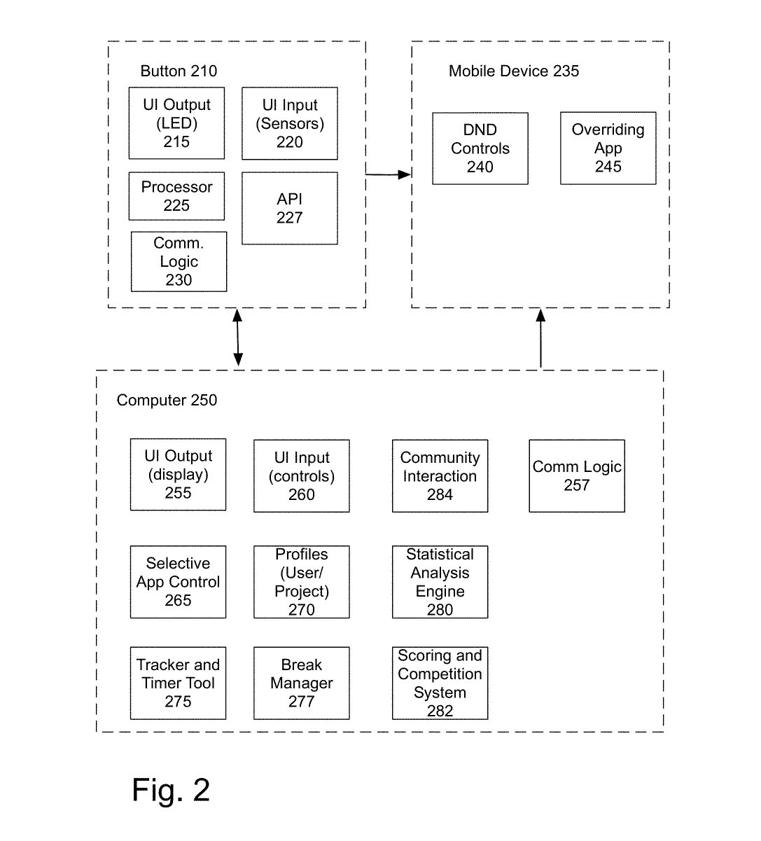

FIG. 2 is a block diagram of one embodiment of the button, computer system, and auxiliary device. The button 210, in one embodiments includes user interface outputs 215. User interface outputs 215 may include LEDs, vibration motors, and potentially a microphone to output voice. In one embodiment, though the button 210 has a limited UI output 215, it can output data through the computer 250. In on embodiment, the UI output 215 provides an intuitive and non-intrusive way of communicating with the user, supported by the UI output 255 of the computer.

In one embodiment, button 210 interfaces with computer 250 through application programming interface (API) 227. The API 227 also enables other applications which track time, and/or control the user's computer system to utilize button 210.

In one embodiment, the button 210 includes UI Input 220 which may include buttons, proximity sensors, heat sensors, and other ways of communicating with the button 210. In on embodiment, the button 210 UI input 220 includes a button to activate a session and terminate a session, and one or more sensors.

The button 210 includes a processor 225, and communication logic 230 so that button 210 can communicate with computer 250 and/or mobile device 235. The communication logic 230 may be a wired and/or wireless connection. In one embodiment, communication logic 230 uses a local area network such as BLUETOOTH™ to connect to mobile device 235. In one embodiment, connection logic 230 uses a wired connection to connect to computer 250.

Mobile device 235 includes, in on embodiment, do not disturb (DND) controls 240 and/or an overriding application 245. In one embodiment, these two aspects are designed to remove the mobile device 235 as a distraction. In one embodiment, the mobile device 235 may also include other aspects, illustrated as part of computer 250, if the user utilizes the mobile device 235 for work.

The computer 250 includes UI output 255, which communicates the state of the system to the user, and guides the user. In one embodiment, the UI output 255 includes a display on the user's computer screen, such as an icon, pop-ups, etc. In one embodiment, the application associated with the button 210 resides in the menu bar and provides visual feedback that is not intrusive. UI input 260 provides controls, and in one embodiment enables the user to set various settings of the button 210 and application, to optimize the system for the user. Selective application troll 265 provides the warning system to enable the system to warn the user when the user initializes an application which is distracting.

Profiles 270 in one embodiment include user profiles and project profiles. User profile defines the specific characteristics and device use patterns of the particular person who is registered as the user of the button 210 and application. In one embodiment, a single button/application may support multiple profiles, for example by tracking based on the user log-in into computer 250. The project profiles include the set of applications associated with each project type, which may be selected by the user, as will be discussed in detail below. Selective application control 265 is based on the user profile and project profile.

Tracker and timer tool 275 tracks the user's usage patterns, and utilizes selective application control 265 to ensure that the user is guided to a productive workday. In one embodiment, tracker and timer tool 275 also provides time tracking. In one embodiment, the user may set a session objective, indicate how long they want to work on it, then hit the button. In one embodiment, the tracker and timer tool 275 may make the time tracking data available to other applications. Break manager 277 manages breaks between focus sessions.

Statistical analysis engine 280 analyzes the data tracked, including lengths of focused time, and other aspects of the user's work. In one embodiment, the statistical analysis engine 280 also receives direct feedback from the user, in addition to the automatically captured data. For example, the user may be asked at the end of the day how efficient they felt, and what they want to improve. This may be used to suggest modifications to the project profiles 270.

Scoring and competition logic 282 scores the user's focus sessions and breaks, for length, consistency, and efficiency. In one embodiment, scoring and competition logic 282 enables the user to compete with other users, in focus times, utilization of break times, tracking, use of other productivity tools, etc. This will be described in more detail below.

Computer 250 encompasses, in one embodiment, the user's own computer, and a server which provides global data and suggestions to the user. In one embodiment, the system can be fully functional without any server, or global data sharing. In one embodiment, calculations, profile suggestions, competition, and other aspects reside on a server.

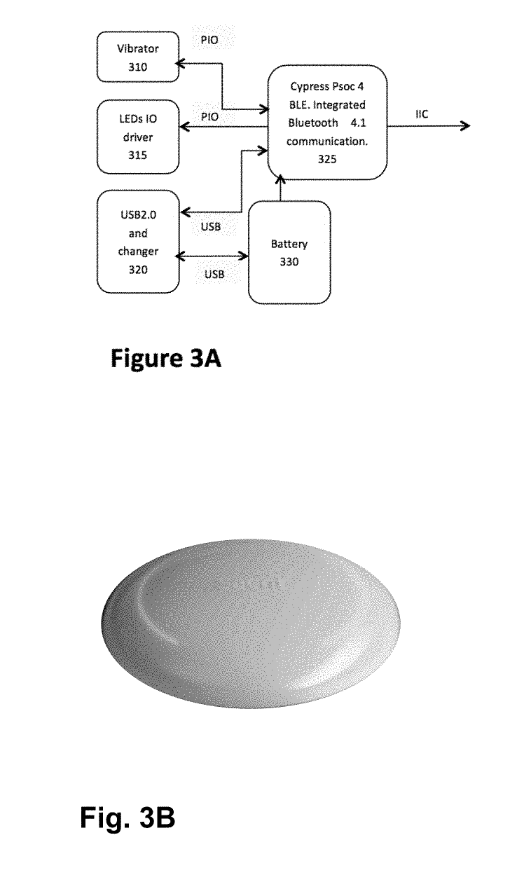

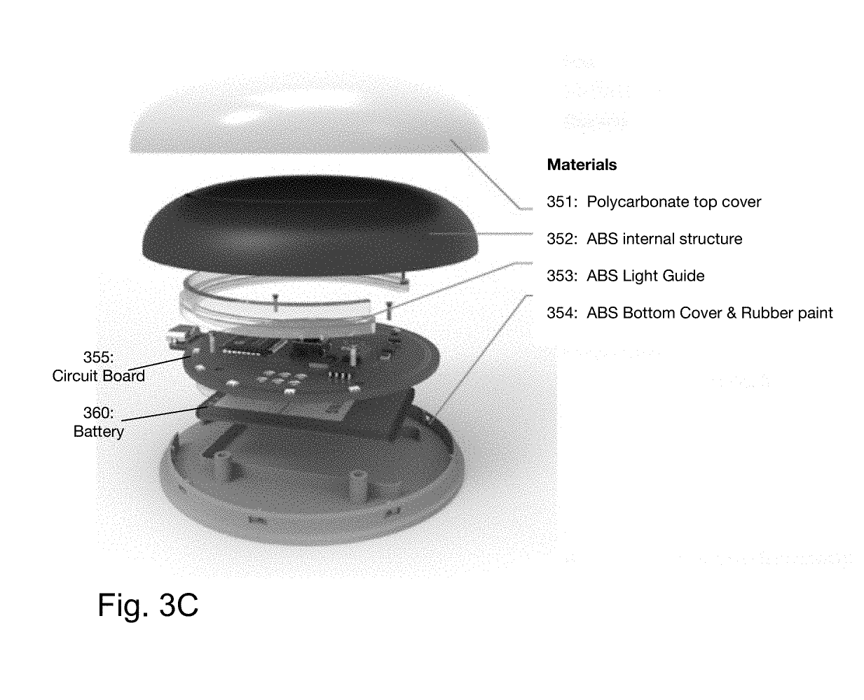

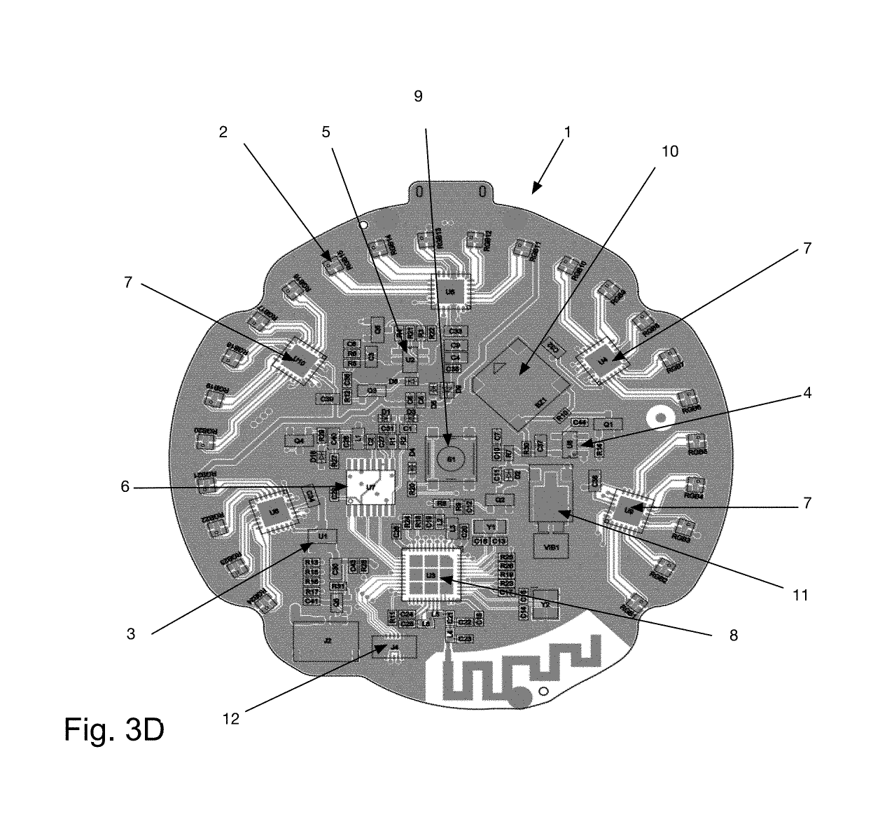

FIG. 3A is a diagram of one embodiment of the circuitry of the button. The button 300 in one embodiment includes a system on a chip 325, including a plurality of sensors. In another embodiment, a processor and separate sensors may be utilized. In one embodiment, the system on a chip 325 includes integrated communications, such as Bluetooth BLE (low power). In one embodiment, the chip is Cypress PSoC 4 BLE chip. This chip includes sensors for touch and gesture detection, and has sufficient processing power to enable communication with the desktop device, and controlling all UI features.

The outputs of the button 300 include one or more of a vibrator 310, one or more LEDs, and a speaker. Vibrator provides haptic feedback. In one embodiment, an LED input/output (IO) driver 315 is coupled to the processor 325. In one embodiment, the button includes a battery 330. In one embodiment, the battery is between 2.5-3.8V. The battery may be charged via USB 2.0 charger. Alternative connector types may be utilized.

FIG. 3B an illustration of an exemplary embodiment of the button. As can be seen, the button, in one embodiment is a unitary piece ringed by a set of LEDs visible through the top surface. In one embodiment, the LEDs are multi-color, enabling the device to provide multiple types of messaging. In one embodiment, the system includes ten small LEDs. The LEDs are used to provide timing feedback on a session. In one embodiment, for example, for a 20 minute session, an LED is lit every 2 minutes, so that the last LED is lit when the 20 minutes are done. In another embodiment, the LEDs are extinguished one at a time, so that It starts with a full arc, and slowly the lights go out until the session is completed. Alternative methods of using the LED to provide a physical and visual feedback of the time may be used. The number of LEDs, and the colors available, are also arbitrary. For example, the system may be implemented with 60 LEDs, or 6. The LEDs may be all a single color, full color RGB, or somewhere in between. In one embodiment, the system may further provide color-based feedback, for example turning green when the user is in the zone, and efficient in starting and completing sessions.

FIG. 3C is an exploded diagram of one embodiment of the construction of the button. As can be seen the layers include 351, a translucent top cover. In one embodiment, the top cover is transparent and internally coated with a white or other light colored paint. The internal structure 352 is made of ABS. The light guide 353 provides support for the LEDs, and structural support for the circuit board 355. In one embodiment, it is made of ABS plastic. The bottom cover 354 provides the closing element, and structural support for the circuit board 355 and battery 356. In one embodiment, the bottom cover 354 is also made of ABS plastic in one embodiment. In one embodiment, the bottom element 354 is rubberized to keep the button from sliding. In one embodiment, the case is coupled together using screws, which go through the circuit board 354.

FIG. 3D is an exemplary circuit diagram of the button. The elements in the circuit diagram are as follows:

| Item | Manufacturer Part Number | Description |
|---|---|---|
| 1 | Saent_MB_v2.1PCB | Main PCB |
| 2 | LED, 19-237/R6GHBHC-C01/2T, 1.6*1.6 mm | Halo display |
| 3 | LDO (100 mA), XC6206P332MR, SOT-23 | Power management |
| 4 | LDO (200 mA), XC6234H301VR-G, SOT-25 | Power management |
| 5 | Charger IC, TP4057, SOT-23-6 | Charging management |
| 6 | USB to UART, FT203X, SSOP | USB connection for Win |
| 7 | LED Drive, AW9523BTQR, QFN24PIN, 4*4 mm | LED color/time driver |
| 8 | BLE4.0 v3 [symbol] , NRF51822-QFAA, 6*6 mm, QFN | BLE4.0 communication |
| 9 | Button 250 g, 5*5*2.5 mm | Button for switch |
| 10 | Buzzer, HYG-7525A | Beep notice |
| 11 | Motor, BAL-3610 | Vibration notice |
| 12 | FPC Touch Module IC: CP2615 | For touch function |

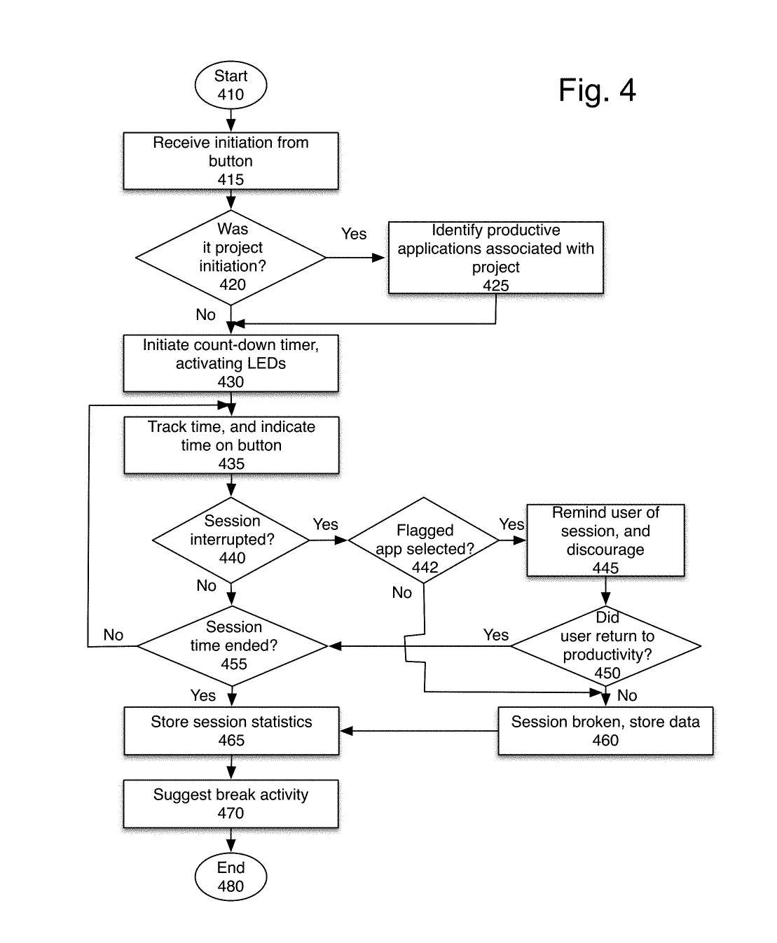

FIG. 4 is an overview flowchart of one embodiment of using the system. The process starts at block 410. In one embodiment, the process starts when the user initiates the system.

At block 415, a session is initiated. In one embodiment, the session is initiated using the button. In another embodiment, the session may be initiated using a soft control on the user's computer system. In one embodiment, the system automatically places any paired mobile devices into a “do not disturb” mode, when a session is initiated. This is to reduce distraction by external devices. In one embodiment, if the mobile devices cannot be placed in such a mode, an application may be initiated on the mobile device, which tracks whether the device is being used/interacted with.

At block 420, the process determines whether the initiation was a project initiation. In one embodiment, the user may initiate a “generic” session, or a “project session.” Project sessions in one embodiment may be selected by using a swipe or other unique control associated with a particular type of session. In one embodiment, the user may define the types of projects that can be initiated.

If it is a project session, at block 425 the applications associated with this project type are identified by the system. For example, a designer may set a “design session” which designates only PHOTOSHOP® by Adobe, design websites, and a text editor as productive applications for that project type. In one embodiment, this is set up by the user head of time, when the project type is identified. In one embodiment, the system may suggest different project types, based on observed data.

At block 430, the count-down timer is identified, and LEDs are activated on the button, when available. In one embodiment, if the button is not available, the countdown may be shown on the user's computer screen.

At block 435, the time is tracked against the user's designated length of session. The time is indicated on the button and/or computer screen.

At block 440, the process determines whether the session is being interrupted. The session may be interrupted when the user selects a non-productive application. The session may also be interrupted by the user, by indicating that the session should be terminated.

At block 442, the process determines whether a flagged application is selected. Flagged applications are applications tagged “bad” or “unproductive” or “not part of this project type.” In one embodiment, applications are categorized into “good” (e.g. appropriate for this particular project), “evil” (e.g. not appropriate for this particular project, and “neutral” (either not classified or potentially good or evil.) In one embodiment, depending on the strictness of the user's settings, flagged applications may be all neutral, evil, and unlabeled applications, or just evil applications. Another way of saying this is that flagged applications are considered unproductive for the particular session type.

If the interruption was not an unproductive application, the process continues directly to block 460, and the session is broken. In one embodiment, the user can log such interruption events. In one embodiment, when the user is interrupted, the user may indicate, on the button or via the computer, the type of interruption (e.g., a colleague, a phone call, nature's call, etc.). In one embodiment, the indication may be via the button, using taps or swipes to select the type of interruption.

If the user selected a flagged application, at block 445 the user is reminded of the session, and encouraged to remain productive. In one embodiment, if the user is in a “police” or “monk” mode, he or she may simply not be able to select an unproductive application at all. In one embodiment, the computer may need to be rebooted to exit from a session in “police” or “monk” mode. In another embodiment, the user may terminate the application, in police or monk mode as well. In one embodiment, the system also tracks whether the user interacts with his or her mobile phone or device which is paired with the button. Such interruptions are also considered “selection of an unproductive application,” in one embodiment.

At block 450, the process determines whether the user returned to productivity. If so, the process returns to block 455. If the user did not return to a productive application, at block 460 the session is broken. The process then continues to block 465.

If the user did not select an unproductive application at block 440, or returned to productivity at block 450, at block 455 the process determines whether the session time has ended. If not, the process returns to block 435 to continue tracking time and indicate the elapsing of time on the display.

If the session has ended, by the time expiring or the user breaking the session, at block 465 the session statistics are stored. In one embodiment, the statistics provide interesting insights into the user's productivity. For example, it can provide data about which day of the week are the user is most focused, when peak distraction time is, how often the user checks email per day and how this impact focus. These simple insights can go a long way toward helping the user improve their work habits and focus.

In one embodiment, at block 470 a break activity is suggested to the user. By suggesting the use of the break, rather than immediately starting a subsequent session, the user is encouraged to maximum productivity. The process then ends.

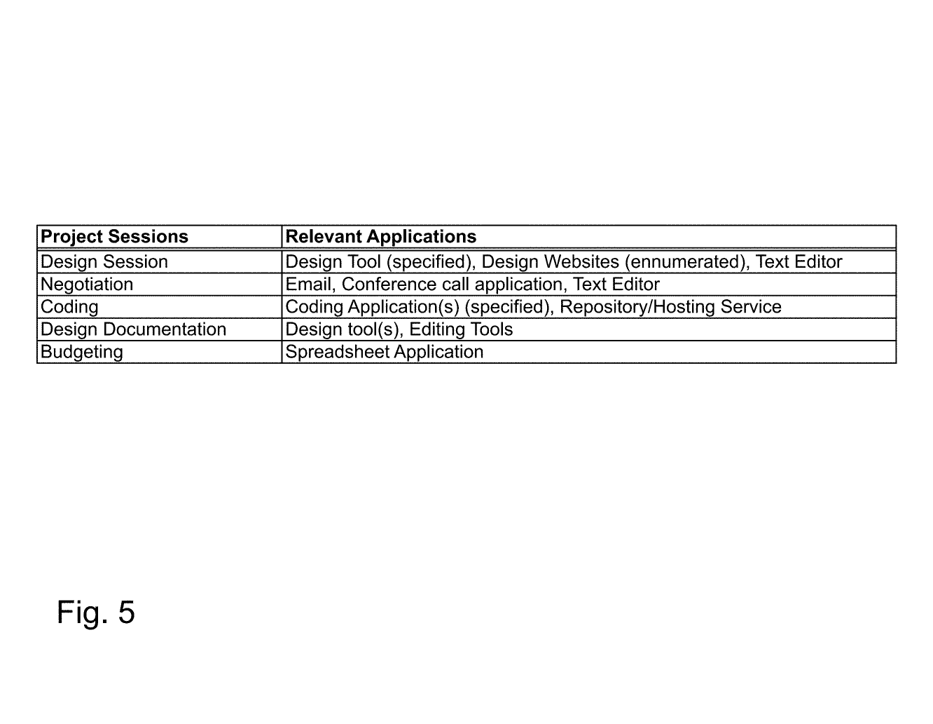

FIG. 5 is a table of exemplary project selections, for various types of projects. Note that these are merely exemplary types of projects & selections, for one particular type of user. In one embodiment, the user may define any projects appropriate to the user's use preferences. In one embodiment, if the user defines his or her job description, the system may create suggested project types. For example, suggested project types for a designer may be the ones listed in FIG. 5. For a manager, suggested project types would differ. In one embodiment, the system collects data from users defining their job & project types, and utilizes often-used project types as suggestions. In one embodiment, a particular project session may be selected using a gesture command. For example, the user may tap the button and then swipe diagonally across to initiate a particular type of session. These fast-launch gestures may be defined by the user manually or provided by the system automatically, with the user having the ability to alter them.

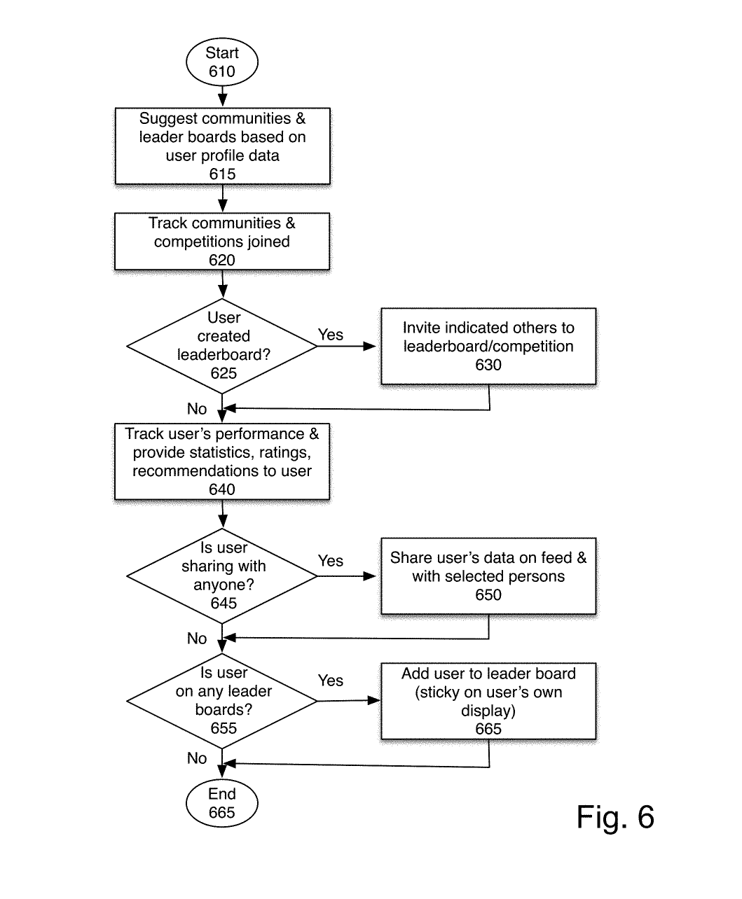

FIG. 6 is a flowchart of one embodiment of community and competition process. The process starts at block 610.

At block 615, communities and leader boards are suggested to the user. In one embodiment, this occurs when the user initially sets up an account with the system. In one embodiment, this may also occur when a new leaderboard is established with a description that may be of interest to the user, for example a leaderboard associated with other's in the user's field, or company.

At block 620, the system tracks what communities and competitions the user has joined. Competitions in one embodiment include leader boards and comparisons of productivity and focus. In one embodiment, this may include length of focused sessions and observation of breaks appropriately.

At block 625, the system determines whether the user has created a leader board. Users may create their own leaderboards, with friends, coworkers, or others. If so, at block 630, invitations are sent to the people invited by the user. This ensures that the user's data is not shared with others without the user's consent.

At block 640, the system tracks the user's performance, and provides data to the user. Data may include statistics such as the amount of time spent in focused time, the types of interruptions etc. In one embodiment, the rating is an abstracted value, which may take into account other factors, such as the use of productivity applications, how often the user checked his or her email, and other behavioral analytics. In one embodiment, recommendations may also be provided. In one embodiment, the system tracks productive people, and attempts to move users into a pattern that appears to lead to more productivity. For example, the system may note that the user is overall more productive when starting at 9:30 a.m. rather than at 7:30 a.m., or when ending at 6 p.m. rather than 9 p.m. This kind of information is provided to the user, in one embodiment, to encourage improvements in productivity.

At block 645, the process determines whether the user is sharing his or her data with anyone. Communities, in general, share data. The user may also choose to share with selected individuals. If user data is shared, at block 650, the user's data is posed on the appropriate feed(s) for the people or communities the user shares with. Data may also be shared via email, text, social media posts, or other methods.

At block 655, the process determines whether the user is on any leaderboards. If so, at block 655 the user's data is included on the leaderboard(s). In one embodiment, for the user's own display, the user is always shown. So, the system may show the top 10 users, and the user who is viewing it with his or her own rating (which may be below 10). In this way, the user is kept engaged, with a feed of information from connected communities and users. In one embodiment, the system also

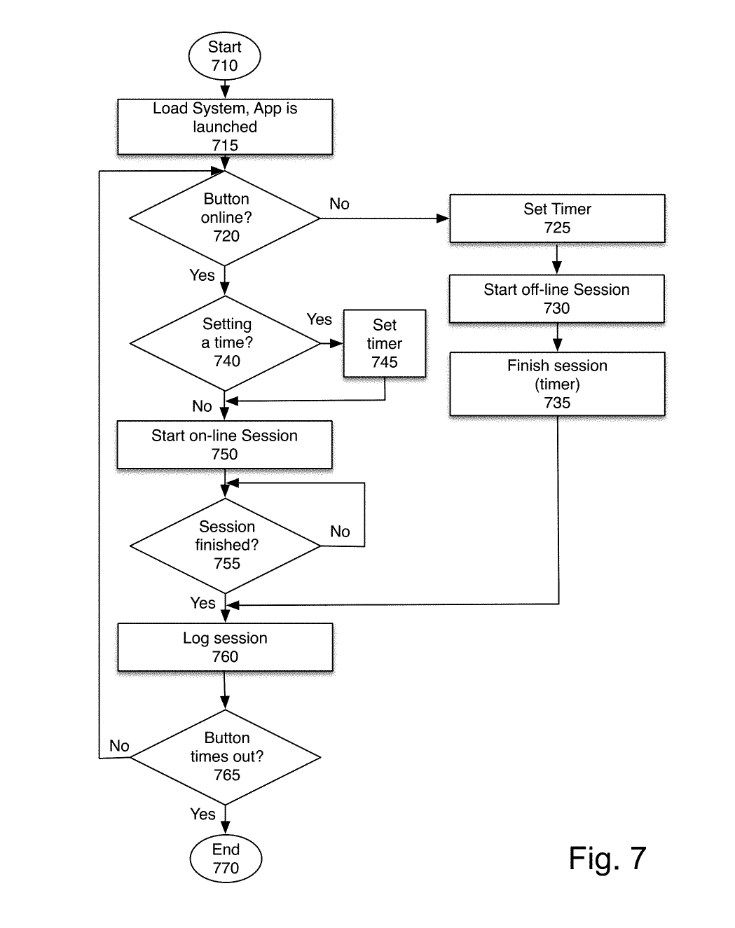

FIG. 7 is a flowchart of one embodiment of the activation of the button. The process is initiated at block 715, in one embodiment by holding the start button. In one embodiment, holding the start button 1.8 seconds or longer turns on the button, and initiates the associated software application on the user's device. When system has loaded, the first LED will blink twice in blue a color. In one embodiment, the LED blinks in breath rhythm.

At block 715, the drive software is launched, and the power supply system is activated.

At block 720, when the system is turned on, the wireless network connection will activate the “find me” function. In one embodiment, the wireless network connection is a Low Power Bluetooth (BLE) connection.

In one embodiment, the button will have a default BLE password. The button will then connect to targets through Bluetooth. If the target device is trying to connect to a button, the first LED will blink twice with orange color and then turn to blue and stop blinking when the button's system's loading is complete. The button, in one embodiment, will recognize which operational condition it is operating under, whether it is connected through a wired (USB) or wireless (BLE) connection. The USB connection will always be higher priority, and preferentially used when available.

At block 720, the system determines whether the button is online. The on-line condition is defined as that when the button is connected to the software which is running on a computer, connected via Bluetooth, USB, or another mechanism. The computer may be a personal computer, such as a desktop or laptop computer. The computer may also be a mobile computer, such as a smart phone or tablet computer, in one embodiment. If the button is online, the process continues to block 740.

When the button is online, the user can either set default timer length through the computer use interface, or manually on the device, determined at block 740. In one embodiment, if the user does not set a specific time, at block 745, the session is started with a default time, at block 750. In one embodiment, users can set the time by holding the middle button. In one embodiment, the system counts up by a set interface. For example, in one embodiment, every 1.4 second will activate 5 min of work time—LEDs will be turned on in sequence as each additional time unit is added to the session. In one embodiment, the default maximum time is 50 min and the minimum time is 5 min.

After the user has set the time, they can initiate the session, at block 750. The session can be initiated by clicking the button to start the work session. The session can also be initiated by a sweep (touching or non-touching swipe), to select a particular project profile for the session. The session can also be initiated from the computer, rather than the button.

At block 755, the process determines whether the session is finished. The session may be finished when the time has elapsed, or the user has broken the session, for example by click to the Facebook application, or another application which is indicated as breaking the focus session.

At block 760, After a finished session, the software will log the session's results, including time, work completed, and whether the user finished their target focused time, e.g. whether the user terminated the session by multitasking or worked through the time. The process then determines whether the button times out, at block 765. If not, the button remains online, and awaiting the next session initiation. Otherwise, the button turns off or enters a sleep mode, and the process ends at block 770.

If at block 720, the button was offline, the process continues to block 725.

At block 725, under off-line conditions, user can set the time by holding the middle area of the button. In one embodiment, for every 1.4 seconds the button is held, it will add 5 minutes to the session, and the LEDs will be turned on in sequence. In one embodiment, the default maximum time is 50 min and the minimum time is 5 min. This type of “egg timer” use may be useful for example in meetings to keep them on track and focused, or when using tools that are not network connected such as physical drafting tools.

At block 730, after the time has been set, the user can start the session by clicking the button.

At block 735, under the off-line condition, the session is finished. In one embodiment, when the time is up, the last LED will blink twice. Alternative all of the LEDs may blink, or another pattern may be displayed. This enables the use of the button as an “egg timer” of sorts, even without the presence of the computer. In one embodiment, the timed data of “offline activities” may be synced back to the software and used in reports, productivity score assessment, etc. In this way, the device also becomes a tracker/tool for analyzing activity/time away from the computer. In one embodiment, the session is logged at block 760, In one embodiment, in off-line mode, the session data may be stored on the button, until the button is online again.

For the system, in one embodiment, after the end of the session, at block 765, if user gives no more operational inputs to button during a preset period, the button will automatically turn off. In one embodiment, that period is 3 minutes. Moreover, under online condition, the button may go into “sleep function.” In one embodiment, an LED will blink with breath rhythm. User can wake the device by a single click of the button. If user closes the software or cuts off the Bluetooth connection, the button will turn off directly, in one embodiment. In one embodiment, the button and software are independent. In one embodiment, while in online mode the software will continue to run if the button turns off.

Of course, though the above processes are illustrated as flowcharts, they can be implemented in various ways. For example, it could be interrupt driven, where the system does not monitor for occurrences but is alerted to them using an interrupt for a command, occurrence, or action by the user. Additionally, the ordering of the various exit and warning conditions is arbitrary.

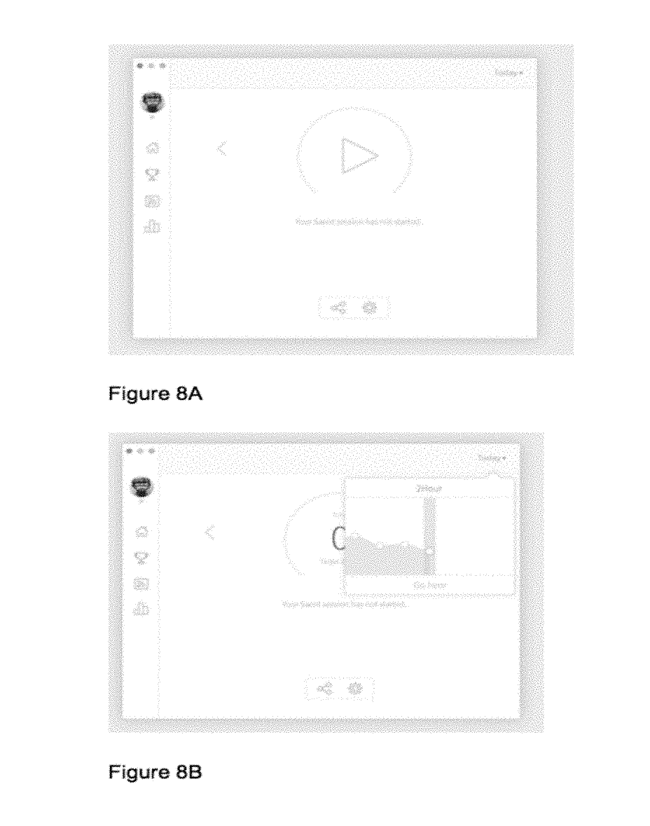

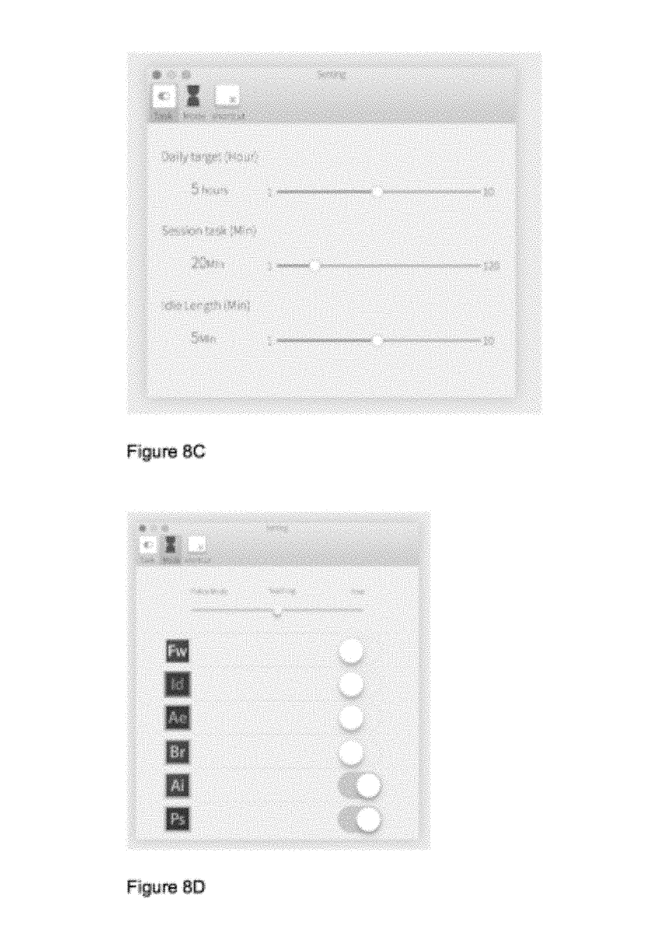

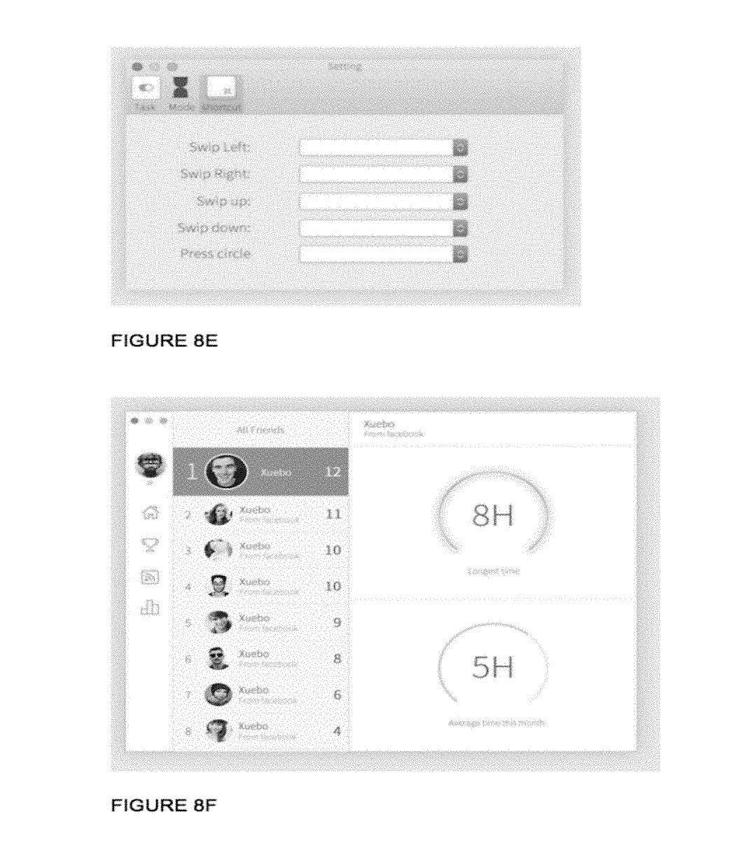

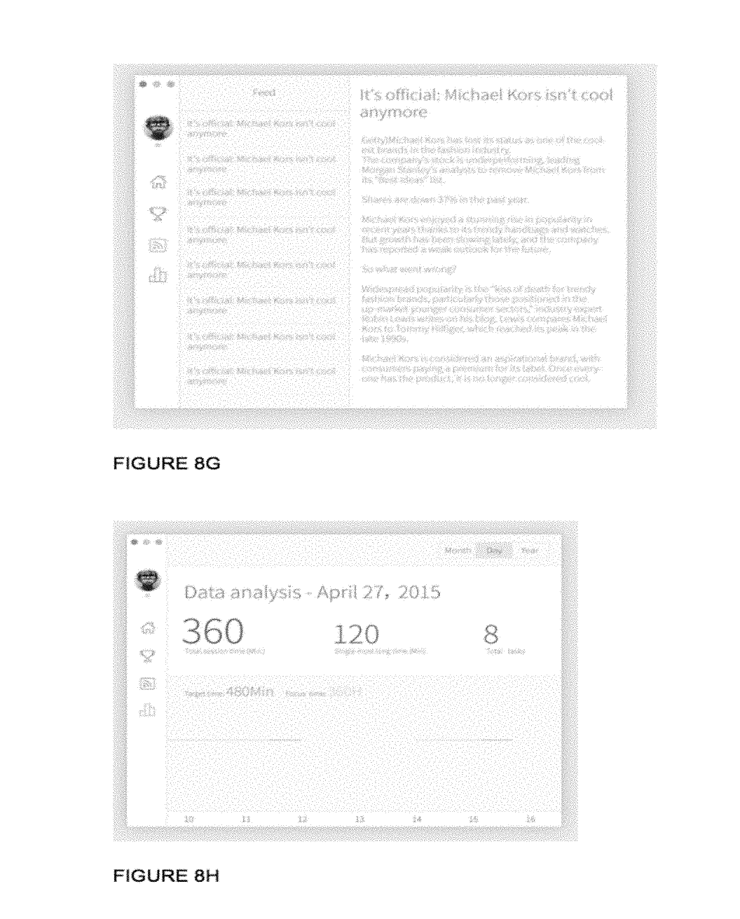

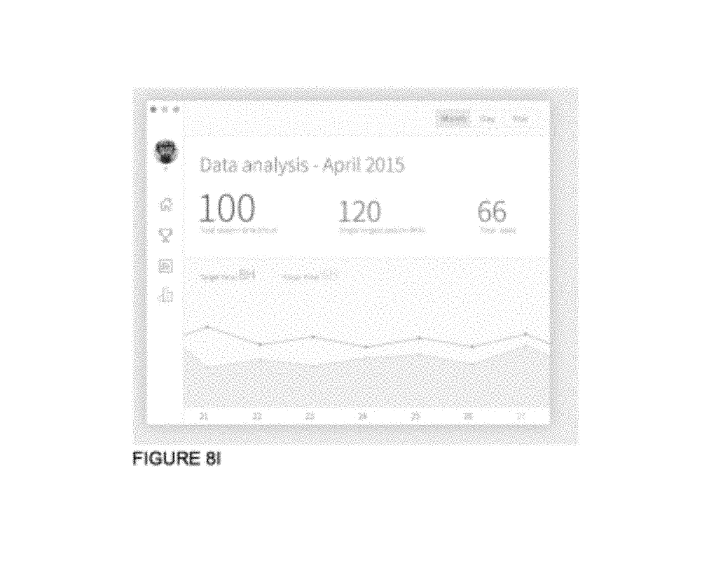

FIG. 8A-8I are exemplary user interface features.

FIG. 8A shows one embodiment of the initiation screen, using the soft button. The user may start a session by clicking the button. FIG. 8B shows one embodiment of the basic data shown for a day.

FIG. 8C shows one embodiment of configuration screen. Here a user is able to indicate three important time-based settings: Daily total target of focused hours, individual session length, and idle time, which is the “cut-off” time when the program decides someone is not at their computer anymore. In one embodiment, the total goal of focused hours may be set between 1 and 10, and session length may be set between 10 minutes and 4 hours. Idle length in one embodiment, is between 30 seconds and 5 minutes.

FIG. 8D shows one embodiment of a screen that allows the user to mark different applications and websites as productive/unproductive or good/evil/neutral or unflagged/flagged, e.g. websites and applications that should and should not be part of a productive session. When the user is in a session, the system tracks whether the user is utilizing an unproductive/evil/flagged application, or visiting an unproductive/evil website. In one embodiment, the system comes with a set of default unproductive applications & site (for example games are considered unproductive by default, as are social media sites.) The user, in one embodiment, can reconfigure these settings, so for example a user who works in social media management can set certain sites associated with that to productive. In one embodiment, this can also be done as a user utilizes his or her computer during normal activities. By turning on “teaching mode”, the user will get a notification at the right top of the screen whenever they switch to a new application/site. The user can then indicate whether they deem this site or application “productive” or “unproductive”. They may also associate the site/application with particular project types. This makes the teaching of the system intuitive and non-intrusive and avoids the user having to go through a long list of apps and sites and manually adding things. In one embodiment, this notification will automatically come up (even outside of teaching mode) when an app/site is still marked as “uncategorized” is activated by the user. In one embodiment, during a session such queries may be stored, to keep the user focused and productive. After the session ends, the user may be asked to classify any new applications or sites.

This screen also shows three possible modes which may be used, in one embodiment. The modes are Police, Teaching, and Free, in this example. These modes may also be referred to as Monk/Teaching/Normal. In Police mode, the user cannot go to an unproductive site or application w. The free mode provides a nudge/suggestion guiding the user away from unproductive sites but allowing the user to override. The teaching mode allows tracking of the user's activities, to categorize applications, during normal use of the system, as described above.

FIG. 8E shows one embodiment of a gesture setting screen. Using this screen, the user can assign “shortcuts” to specific applications, or project sessions using the button. In one embodiment, this screen is only available when a user has a button connected/registered. This enables the user to access a particular application, or initiate a project session, with a single gesture. The gesture may be a touching gesture, such as a swipe, or waving gesture above the device.

FIG. 8F shows an exemplary leader board, for a competition. In one embodiment, the user will always be visible in the leaderboard, with the user's score “sticky” to the bottom or top of the ranking depending on the user's score. By selecting a user on the leaderboard, the right panel will show details on the user's score breakdown. By clicking on the gray bar with “all friends”, the user will get a dropdown from which different competition groups can be chosen.

In one embodiment, the user may create new leaderboards. This enables the user to create an appropriate group of friends, coworkers, etc. In one embodiment, organizations may set up leader boards, that may be joined by the user. In one embodiment, users may be invited to join a leaderboard created by someone else, and when a user creates a leader board those individuals the user added would receive an invitation.

Leaderboards may include a “daily board”, a “longer term board” and a “lifetime board.” In one embodiment, users may share their position on the leaderboard via social media.

FIG. 8G is one embodiment of a feed that may be provided to the user. In one embodiment, the feed may include links to relevant articles, tweets and other social media updates, friends' achievements.

FIG. 8H-8I show one embodiment of reports/insights for a day or a longer period, such as a month. In one embodiment, the length of time shown may be adjusted by the user ranging from a day (or work day, e.g. portion of a day) to the lifetime of the system use. These reports enable the user to analyze their work behavior.

The standard view the user will get when arriving in the reports section is a breakdown of the current day, like in the below screen. Out of each hour of the day, the user sees how many minutes (points) they focused that hour. This will help the user to determine which hours of the day was the most productive.

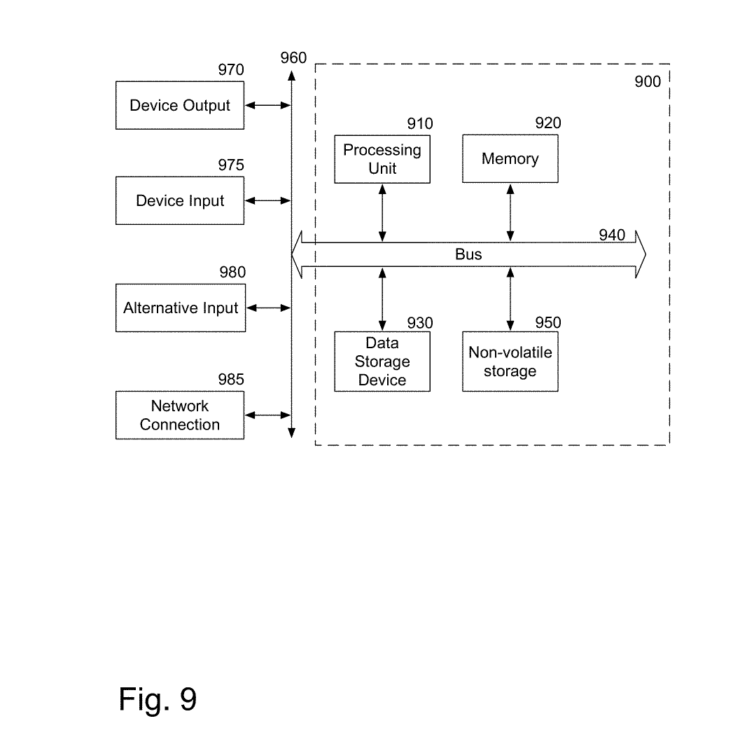

FIG. 9 is a block diagram of one embodiment of a computer system that may be used with the present invention. It will be apparent to those of ordinary skill in the art, however that other alternative systems of various system architectures may also be used.

The data processing system illustrated in FIG. 9 includes a bus or other internal communication means 940 for communicating information, and a processing unit 910 coupled to the bus 940 for processing information. The processing unit 910 may be a central processing unit (CPU), a digital signal processor (DSP), or another type of processing unit 910.

The system further includes, in one embodiment, a random access memory (RAM) or other volatile storage device 920 (referred to as memory), coupled to bus 940 for storing information and instructions to be executed by processor 910. Main memory 920 may also be used for storing temporary variables or other intermediate information during execution of instructions by processing unit 910.

The system also comprises in one embodiment a read only memory (ROM) 950 and/or static storage device 950 coupled to bus 940 for storing static information and instructions for processor 910. In one embodiment, the system also includes a data storage device 930 such as a magnetic disk or optical disk and its corresponding disk drive, or Flash memory or other storage which is capable of storing data when no power is supplied to the system. Data storage device 930 in one embodiment is coupled to bus 940 for storing information and instructions.

The system may further be coupled to an output device 970, such as a cathode ray tube (CRT) or a liquid crystal display (LCD) coupled to bus 940 through bus 960 for outputting information. The output device 970 may be a visual output device, an audio output device, and/or tactile output device (e.g. vibrations, etc.)

An input device 975 may be coupled to the bus 960. The input device 975 may be an alphanumeric input device, such as a keyboard including alphanumeric and other keys, for enabling a user to communicate information and command selections to processing unit 910. An additional user input device 980 may further be included. One such user input device 980 is cursor control device 980, such as a mouse, a trackball, stylus, cursor direction keys, or touch screen, may be coupled to bus 940 through bus 960 for communicating direction information and command selections to processing unit 910, and for controlling movement on display device 970.

Another device, which may optionally be coupled to computer system 900, is a network device 985 for accessing other nodes of a distributed system via a network. The communication device 985 may include any of a number of commercially available networking peripheral devices such as those used for coupling to an Ethernet, token ring, Internet, or wide area network, personal area network, wireless network or other method of accessing other devices. The communication device 985 may further be a null-modem connection, or any other mechanism that provides connectivity between the computer system 900 and the outside world.

Note that any or all of the components of this system illustrated in FIG. 9 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 920, mass storage device 930, or other storage medium locally or remotely accessible to processor 910.

It will be apparent to those of ordinary skill in the art that the system, method, and process described herein can be implemented as software stored in main memory 920 or read only memory 950 and executed by processor 910. This control logic or software may also be resident on an article of manufacture comprising a computer readable medium having computer readable program code embodied therein and being readable by the mass storage device 930 and for causing the processor 910 to operate in accordance with the methods and teachings herein.

The present invention may also be embodied in a handheld or portable device containing a subset of the computer hardware components described above. For example, the handheld device may be configured to contain only the bus 940, the processor 910, and memory 950 and/or 920.

The handheld device may be configured to include a set of buttons or input signaling components with which a user may select from a set of available options. These could be considered input device #1 975 or input device #2 980. The handheld device may also be configured to include an output device 970 such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a kiosk or a vehicle. For example, the appliance may include a processing unit 910, a data storage device 930, a bus 940, and memory 920, and no input/output mechanisms, or only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism. In one embodiment, the device may not provide any direct input/output signals, but may be configured and accessed through a website or other network-based connection through network device 985.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 910. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A system comprising:
a physical button to initiate a session, the session designed to enable a user to be focused, the physical button communicating with a software application through a network connection;
a computer system including the software application to track how the user utilizes the computer;
the button to provide a visual display of a count-down timer for the session, to encourage the user to maintain focus through the session; and
the computer system to track whether the user remains productive through the session, and to generate statistics at an end of the session, the statistics usable by the user to encourage focus.

2. The system of claim 1, wherein the session may be one of a plurality of types of sessions, each type of session associated with one or more applications that may be used while being productive.

3. The system of claim 2, further comprising:
the software application enabling the user to create a project session type, by defining the project session type and one or more associated applications.

4. The system of claim 3, wherein the button can be used to initiate session for a particular project type, by utilizing a particular gesture.

5. The system of claim 1, further comprising:
the software application, upon detecting that the user selected a flagged application, warns the user to maintain the session.

6. The system of claim 1, further comprising:
a server to receive data from the application on the computer system, the server to track user performance, and create one or more communities and leaderboards.

7. The system of claim 6, further comprising enabling the user to join and/or create a leaderboard, to track performance against a plurality of other users.

8. The system of claim 1, wherein the button comprises a processor and a sensor to recognize touch and gestures made above the button, such that a plurality of gestures may be defined to initiate one of a plurality of types of session.

9. The system of claim 1, wherein the button comprises a processor and a sensor to recognize touch and gestures, such that a gesture may initiate a particular application on the computer system.

10. The system of claim 1, further comprising:
the software application to award points to the user, for focused time, wherein longer focused sessions followed by breaks are rewarded with a highest rating.

11. The system of claim 10, wherein additional points may be awarded for: refraining from multitasking, consistent use of the system, utilizing project tracking software applications, utilizing productivity software, and using the button as a timer in a meeting.

12. A method comprising:
providing a physical button to a user, to enable a focus session, the physical button communicating with a software application through a network connection;
tracking a utilization of a computer by tracking applications activated by the user,
providing a visual display of a countdown timer on the button for the session; and
tracking whether the user remains productive through the session based on the applications activated by the user; and
generating statistics at an end of the session, the statistics usable by the user to encourage focus.

13. The method of claim 12, wherein the focus session may be one of a plurality of types of sessions, each type of session associated with one or more applications that may be used while being productive.

14. The method of claim 13, further comprising:
enabling the user to create a project session type, by defining the project session type and one or more associated applications.

15. The method of claim 13, further comprising:
upon detecting that the user selected a non-productive application, warning the user to maintain the focus session.

16. The method of claim 12, further comprising:
providing data to a server, the server to track user performance, and create one or more communities and leaderboards.

17. The method of claim 12, further comprising:
awarding points to the user, for focus sessions, wherein a longer focus sessions followed by a break are rewarded with a highest rating;
wherein additional points may be awarded for: consistent use of the system, utilizing project tracking software applications, utilizing productivity software, and using the button as a timer in a meeting.

18. A productivity application comprising:
a communication logic to receive data from a physical button to initiate a focus session, the session designed to enable a user to be focused;
a processor to implement a tracker and timer tool, to track applications used by the user, and compare the applications to a set of applications associated with a focus session;
the processor to track whether the user remains productive through the focus session based on the applications used by the user, and to generate statistics at an end of the session, the statistics usable by the user to encourage focus.

19. The productivity application of claim 19, wherein a focus session comprises one of a plurality of types of sessions, each session type associated with one or more applications that may be used while being productive.

20. The productivity application of claim 19 further comprising:
a user interface to provide an intuitive and non-intrusive interface for the system.
